(19) United States
(12) Patent Application Publication
(10) Pub. No.: US 2009/0008353 A1
(43) Pub. Date: Jan. 8, 2009

(54) Packaged Infant Care Products

(75) Inventor: Gregory R. Viggiano, Alexandria, VA (US)

Correspondence Address: SHOEMAKER AND MATTARE, LTD, 10 POST OFFICE ROAD - SUITE 110, SILVER SPRING, MD, 20910, US

(73) Assignee: TRIO CHILD, LLC, Alexandria, VA (US)

(21) Appl. No.: 12/028,316

(22) Filed: Feb. 8, 2008

Related U.S. Application Data
(63) Continuation-in-part of application No. 11/773,245, filed on Jul. 3, 2007.

(51) Int. Cl. A61J 9/06; A61J 9/00

(52) U.S. Cl. 215/11.4; 215/11.1; 215/11.6

(57) ABSTRACT

A bottle of water and powdered infant formula or ready-to-use, pre-mixed, liquid infant formula, juice or other liquid and a ready-to-use sterile feeding nipple device are hermetically sealed within an outer container. Once the outer container is opened, the bottle is removed and the nipple device is then applied to the bottle. The used components may be placed back in the container for reuse or disposal by reapplying an outer lid. In a preferred embodiment, the outer container is a cylindrical can and the bottle is centered within the can by indentations in the wall of the can.

This application is a continuation-in-part of copending U.S. patent application Ser. No. 11/773245, filed Jul. 3, 2007.

### BACKGROUND OF THE INVENTION

This invention relates to packaged infant care products.

New parents encounter many situations in which it is very difficult or inconvenient to keep natural milk on hand for their infants. Infant formula is an alternative in such situations, but even formula spoils and spills. It would be useful to have an infant formula package which had a long shelf life, was easy to crate, ship and carry, and contained everything necessary to feed an infant in one convenient package.

### SUMMARY OF THE INVENTION

An object of the invention is to provide a convenient infant care package which is easily stored, transportable, and keeps everything better organized that is necessary to feed an infant.

These and other objects are attained by packaged infant care products as described below.

### BRIEF DESCRIPTION OF THE DRAWINGS

In the accompanying drawings,

FIG. 1 is a perspective view of packaged infant care products embodying the invention;

FIG. 1a is an exploded view of the embodiment illustrated in FIG. 1;

FIG. 2 is a perspective view of a second “ready-to-feed” embodiment of the invention;

FIG. 3 is an exploded view of the second embodiment, showing the component products;

FIG. 4 shows a ready-to-feed bottle of formula with a feeding nipple being installed.

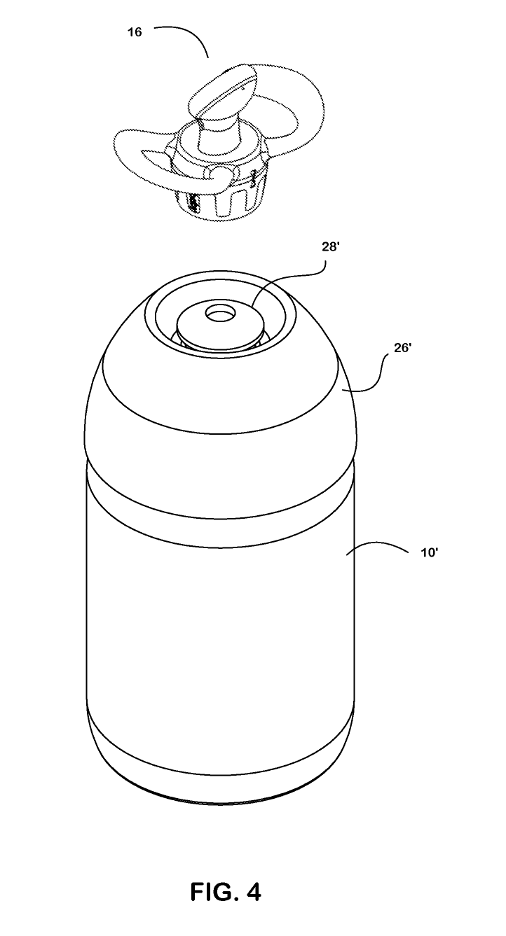

### DESCRIPTION OF THE PREFERRED EMBODIMENT

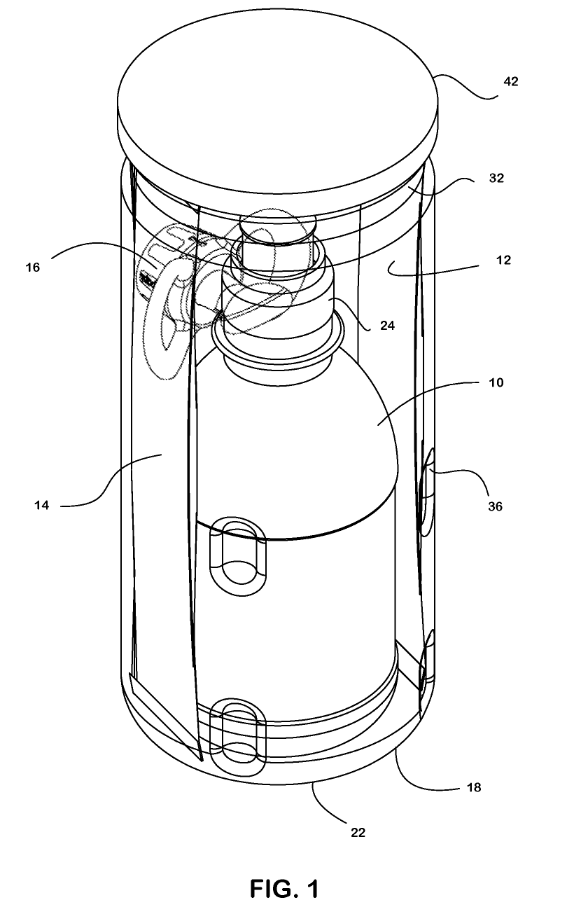

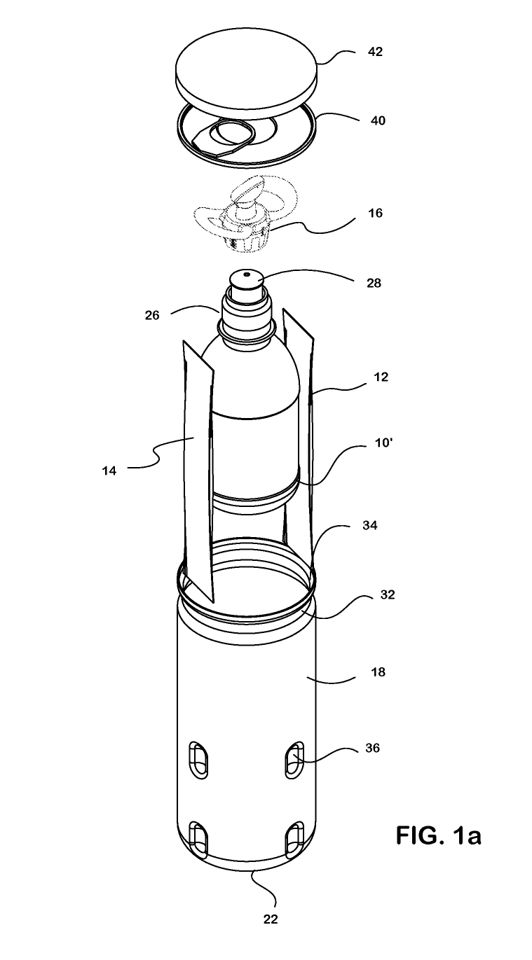

A package of infant care products embodying the invention is shown in FIGS. 1 and 1a. The products in this embodiment are an inner container, more particularly a water bottle 10, and a packaged, pre-sterilized nipple device 16 (which may be a nipple or a nipple/pacifier), and two packets of powdered infant formula 12, 14. These products are placed within a wide-mouthed outer container 18.

The bottle 10 shown in FIG. 1 is a conventional plastic water bottle having an outer diameter substantially less than the inner diameter of the outer container. Its bottom is upwardly convex so that it tends to center itself on the raised bottom 22 of the container. The bottle is filled at the factory with purified water—preferably fluoridated water—and is sealed by a tamper-evident cap or closure 24 (FIG. 1a) having a push-pull valve 26.

The valve 26, which has a circumferential flange 28 at its top, is closed when the valve is in its initial lower position, and opens when the valve is pulled to its upward position. The inner details of the valve are not critical to this invention, and an alternative valve, for example one which is twisted to open and close it, may be substituted. Suitable valves are well known.

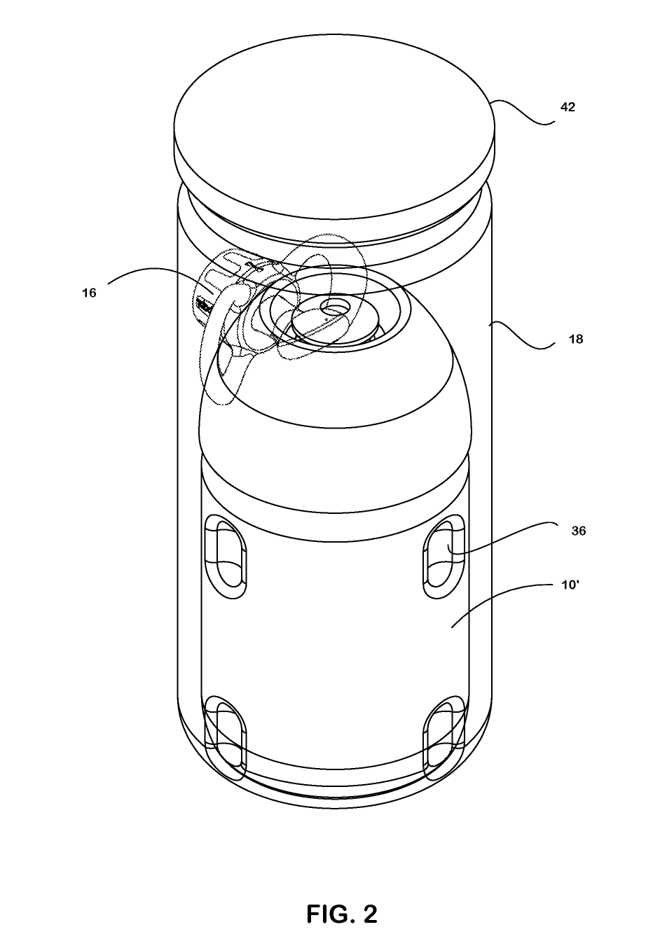

A second embodiment of the invention is shown in FIG. 2. The products in this embodiment are a bottle 10′ containing ready-to-use, premixed, liquid infant formula, instead of water, and a packaged, pre-sterilized nipple device 16. As in the first embodiment, the products are placed within an outer wide-mouthed outer container 18. The bottle 10′ has a removable cap 20, preferably provided with a freshness indicator and/or a tamper-evident feature. Also included is a separate domed closure 26′ specially designed to receive the nipple device: after the cap 20 is removed from the bottle, the closure 26′ is installed in its place. The closure has an integral recessed spout with a peripheral flange 28′, similar to that of the valve shown in FIG. 1. As in the first embodiment, the bottle 10′ in FIG. 2 has an outer diameter substantially less than the inner diameter of the outer container, and its bottom is upwardly convex so that it tends to center itself on the raised bottom of the container.

Another type of container, for example, a bag or box, could be substituted for the water bottle 10′ illustrated in FIG. 1 or the ready-to-feed formula bottle 10′ in FIG. 2.

The remainder of the description applies to both embodiments.

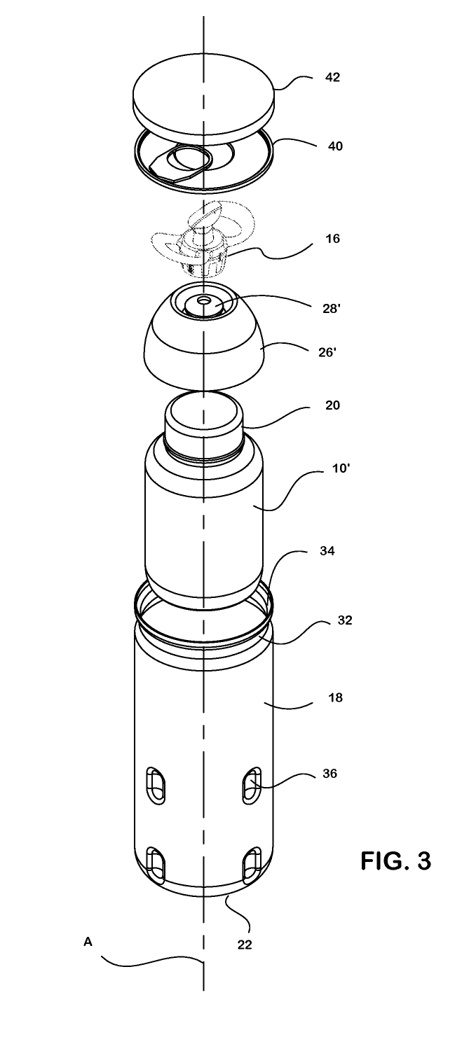

The outer container 18 is substantially cylindrical, having a slight neck 32 just below its mouth 34. The bottom 22 of the container is dished upward to support the bottom of the bottle within. Three or more pairs of indentations 36 are formed in the side wall of the container to stabilize the bottle of water or formula and define an annular space between the bottle and container. In their presently preferred form, the indentations extend lengthwise of the container, parallel to its axis “A” (FIG. 3). The indentations might be replaced by other structures, for example, separate spacers placed inside the outer structure, possibly adhered to its inner surface.

The outer container 18, after being filled with the product components, is hermetically sealed at the factory by a tamper-evident pull top seal 40 (see FIG. 3). The seal can be, for example, a foil panel with a peripheral tear line and may have a integral or attached tab or other structure which one can use to break the seal. The pull top seal 40 shown in FIG. 3 is conventional. U.S. Pat. No. 6,640,993, the disclosure of which is incorporated herein, contains a detailed description of a suitable pull top seal for a wide-mouthed container. It should be understood, however, that other types of sealing elements are within the scope of this invention. For example, the sealing element could be a panel defined by a tear line but only partially removable from the outer container. The selection of an appropriate sealing element is a matter of ordinary skill.

Preferably, the seal 40 of the outer container is overcovered with a snap-on plastic lid 42 so that the outer container can be reused. The lid 42 has an internal circumferential ridge (not shown) designed so that the lid can be pulled off the top of the container and to hold the lid on once it is replaced on the container. The lid enables one to store the contents temporarily, and makes a convenient receptacle for disposing of the packaged components after use. Another type of lid, for example, a screw-off lid might be used.

The nipple/pacifier 16 has a resilient base or socket designed to be pushed onto the circumferential flange 28 of the water bottle's valve or the ready-to-feed bottle's closure 28′. Details of a suitable nipple/pacifier may be found in U.S. Pat. No. 7,032,764, the disclosure of which is incorporated herein by reference. Again, however, this is but one example of a suitable nipple device, and many others—including those not having a pacifier function—may prove suitable. The nipple device is preferably provided wrapped in a sealed bag to maintain the sterile condition of the nipple until it is used.

In use, once the container is opened by breaking the seal 40, the products are removed. If the bottle contains water, dry formula powder may be mixed into the water before feeding. If the bottle contains pre-mixed formula, its cap is removed and the domed closure is installed in place of the cap. In either case, the nipple is then pushed over the peripheral flange 28 or 28′ which holds it on the bottle during feeding.

Once feeding is over, the nipple device may be removed and kept for use as a pacifier, if it has a closable fluid passage. The empty bottle, empty formula packets (if any) and other items may be secured in the outer container so there is no loose trash.

The invention is subject to many modifications and variation. For example, the outer container may be any type of enveloping structure, including a bag such as a Zip-Lok® bag, a box, a blister pack or the like. Additionally, the outer structure might not be hermetically sealed, although that is certainly preferred, inasmuch as the contents are individually wrapped. Elements other than those described, such as Velcro® attachments, elastic bands, instructional and promotional materials and the like may also be included in the outer container. Therefore, the foregoing description and the accompanying drawings should be understood to describe but one example of the invention defined more generally by the following claims.

I claim:

1. An infant formula feeding kit comprising, in combination,
a bottle containing infant formula, juice or water,
a nipple device attachable to the bottle,
an outer container housing the bottle, the formula and the nipple device.

2. The invention of claim 1, wherein the bottle has a closure comprising a freshness indicator.

3. The invention of claim 2, wherein the bottle has a closure comprising a tamper-evident feature.

4. The invention of claim 2, wherein the closure has a valve which can be opened to release liquid from the bottle and closed to prevent leakage of liquid from the bottle.

5. The invention of claim 4, wherein the valve is a push-pull valve.

6. The invention of claim 4, wherein the valve is a rotary valve.

7. The invention of claim 6, wherein the closure includes a spout having a circumferential outwardly protruding flange.

8. The invention of claim 7, wherein the nipple device has a resilient socket so that it can be pushed onto the spout and be retained thereon by the outward protruding flange.

9. The invention of claim 1, wherein the nipple device is a sterile nipple.

10. The invention of claim 9, wherein the sterile nipple is sealed within a sterile envelope inside the outer container.

11. The invention of claim 1, wherein the nipple device is a combined sterile nipple and pacifier.

12. The invention of claim 1, wherein the outer container is a bag.

13. The invention of claim 1, wherein the outer container is a box.

14. The invention of claim 1, wherein the outer container is substantially rigid.

15. The invention of claim 14, wherein the outer container is substantially cylindrical.

16. The invention of claim 14, wherein the container has a side wall with a plurality of indentations therein, the indentations reaching substantially to the external diameter of the bottle, so as to keep the bottle centered in the container.

17. The invention of claim 1, wherein the outer container has a mouth, initially sealed by a removable sealing element, through which the bottle, formula and nipple can be withdrawn once the sealing element has been removed.

18. The invention of claim 17, wherein the sealing element is joined to the outer container along a tear line.

19. The invention of claim 18, wherein the sealing element is a tear-out panel.

20. The invention of claim 1, further comprising a replaceable lid for reclosing the container after the sealing element has been removed.

21. The invention of claim 1, wherein the bottle contains water, and further comprising at least one packet of powdered infant formula in a space between the outer container and the bottle, whereby the contents of the packet may be mixed with the water after the container is opened.
